(19) United States
(12) Patent Application Publication
(10) Pub. No.: US 2020/0004699 A1
(43) Pub. Date: Jan. 2, 2020

(54) VARIABLE-STRIDE WRITE IN A MULTI-POINT BUS ARCHITECTURE

(71) Applicant: QUALCOMM Incorporated, San Diego, CA (US)

(72) Inventors: Lalan Jee MISHRA, San Diego, CA (US); Richard Dominic WIETFELDT, San Diego, CA (US); Helena Deirdre O'SHEA, San Diego, CA (US)

(21) Appl. No.: 16/426,825

(22) Filed: May 30, 2019

Related U.S. Application Data
(60) Provisional application No. 62/690,721, filed on Jun. 27, 2018.

(51) Int. Cl. G06F 13/16; G06F 13/42; G06F 11/10

(52) U.S. Cl. CPC G06F 13/161; G06F 11/1004; G06F 13/4282; G06F 13/1668

(57) ABSTRACT

Systems, methods, and apparatus for improving latency of a serial bus are described. A method performed at a device coupled to a serial bus includes writing a first data byte received in a first field of a datagram from a serial bus to a first register in the slave device, modifying the address pointer by adding or subtracting a stride value provided in a second field of the datagram to obtain a modified address pointer, and writing a second data byte received in a third field of the datagram to a second register in the slave device. The first register may be located at an address indicated by an address pointer and the second register may be located at an address indicated by the modified address pointer. The first register and the second register may be located at non-contiguous addresses.

### PRIORITY CLAIM

This application claims priority to and the benefit of U.S. Provisional Patent Application Ser. No. 62/690,721 filed in the U.S. Patent Office on Jun. 27, 2018, the entire content of this application being incorporated herein by reference as if fully set forth below in its entirety and for all applicable purposes.

### TECHNICAL FIELD

The present disclosure relates generally to serial communication over a shared serial bus and, more particularly, to optimizing latencies associated with time-critical data transmitted over the shared serial bus.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, which may include a multi-drop serial bus or a parallel bus. General-purpose serial interfaces known in the industry include the Inter-Integrated Circuit (I2C or I²C) serial interface and its derivatives and alternatives.

The Mobile Industry Processor Interface (MIPI) Alliance defines standards for the Improved Inter-Integrated Circuit (I3C) serial interface, the Radio Frequency Front-End (RFFE) interface, the system power management interface (SPMI) and other interfaces. These interfaces may be used to connect processors, sensors and other peripherals, for example. In some interfaces, multiple bus masters are coupled to the serial bus such that two or more devices can serve as bus master for different types of messages transmitted on the serial bus. The RFFE interface defines a communication interface that can be for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communications device, multiple antennas and radio transceivers may support multiple concurrent RF links. The SPMI provides a hardware interface that may be implemented between baseband or application processors and peripheral components. In some instances, the SPMI is deployed to support power management operations within a device.

A multi-drop serial bus may be implemented using one or more interface protocols to support high-priority, low-latency communication between an application processor and certain peripherals, and other lower-priority communication. Latency can be adversely affected when multiple devices coupled to the serial bus are concurrently active. Degraded latencies can lead to an increase in dropped packets, session timeouts and retransmissions on the serial bus. As mobile communication devices continue to include a greater level of functionality, improved serial communication techniques are needed to improve latencies and/or improve handling of priority traffic on a serial bus that couples peripherals and application processors.

### SUMMARY

Certain aspects of the disclosure relate to systems, apparatus, methods and techniques that can support increased data rates for a serial bus without increasing bus clock frequency and without modifying encoding of the data transmitted on the data line.

In various aspects of the disclosure, a method performed at a device coupled to a serial bus includes writing a first data byte received in a first field of a datagram from a serial bus to a first register in the slave device, modifying the address pointer by adding or subtracting a stride value provided in a second field of the datagram to obtain a modified address pointer, and writing a second data byte received in a third field of the datagram to a second register in the slave device. The first register may be located at an address indicated by an address pointer and the second register may be located at an address indicated by the modified address pointer. The first register and the second register may be located at non-contiguous addresses. The second field may include a bit indicating whether the stride value is to be added to the address pointer or subtracted from the address pointer.

In one aspect, the datagram includes a stride value that is interleaved between fields carrying a pair of data bytes to be written to non-contiguous registers in the slave device. The datagram may include a register address that serves as an initial address pointer. One or more stride values may be provided in the datagram when the initial address pointer indicates an address within an active variable-stride write region. The active variable-stride write region may be defined by a start address pointer and an end address pointer stored in the slave device.

In one aspect, a parity bit of the first field is set to a first value indicating that the first data byte is to be written to the first register, and a parity bit of the second field is set to a second value indicating that the second field carries the stride value. The address pointer may be modified by adding the stride value to the address pointer. The datagram may include a register address that serves as an initial address pointer. Parity bits in the datagram may be configured to distinguish between register write data and stride values when the initial address pointer indicates an address within an active variable-stride write region. The active variable-stride write region may be defined by registers configured with a start address pointer and an end address pointer stored in the slave device.

In one aspect, the method includes receiving a command code in the datagram, and enabling a variable-stride write mode in response to the command code. The variable-stride write mode may be indicated in mode information received in the datagram. The mode information may define whether parity bits in the datagram distinguish between register write data and stride values. The mode information may define whether the address pointer is to be modified by subtracting the stride value.

In various aspects of the disclosure, an apparatus has a plurality of registers, an interface circuit adapted to couple the apparatus to a serial bus and a processor configured to cause a first data byte received in a first field of a datagram received from the serial bus to be written to a first register. The first register may be located at an address indicated by an address pointer. The processor may be further configured to cause the address pointer to be modified by addition or subtraction of a stride value provided in a second field of the datagram to obtain a modified address pointer, and cause a second data byte received in a third field of the datagram to be written to a second register in the apparatus. The second register may be located at an address indicated by the modified address pointer. The first register and the second register may be located at non-contiguous addresses.

In various aspects of the disclosure, a processor-readable storage medium includes code for writing a first data byte received in a first field of a datagram from a serial bus to a first register in the slave device, modifying the address pointer by adding or subtracting a stride value provided in a second field of the datagram to obtain a modified address pointer, and writing a second data byte received in a third field of the datagram to a second register in the slave device. The first register may be located at an address indicated by an address pointer and the second register may be located at an address indicated by the modified address pointer. The first register and the second register may be located at non-contiguous addresses. The second field may include a bit indicating whether the stride value is to be added to the address pointer or subtracted from the address pointer.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a device configuration for coupling various radio frequency front-end devices using multiple RFFE buses.

FIG. 4 illustrates a device that employs an SPMI bus to couple various devices in accordance with certain aspects disclosed herein.

FIG. 5 illustrates certain aspects of a generalized datagram that may be transmitted over a multi-drop serial bus.

FIG. 6 illustrates a first example of a variable-stride write datagram that enables data to be written to non-contiguous registers in accordance with certain aspects disclosed herein.

FIG. 7 illustrates an example of implementation of selective variable-stride write based on register address space in accordance with certain aspects disclosed herein.

FIG. 8 illustrates a second example of a variable-stride write datagram that enables data to be written to non-contiguous registers in accordance with certain aspects disclosed herein.

FIG. 9 illustrates a third example of a variable-stride write datagram that enables data to be written to non-contiguous registers in accordance with certain aspects disclosed herein.

FIG. 10 illustrates an explicit variable-stride write command code transmitted in accordance with certain aspects disclosed herein.

FIG. 11 illustrates a circuit adapted to implement a variable-stride write protocol in accordance with certain aspects disclosed herein.

FIG. 12 illustrates one example of an apparatus employing a processing circuit that may be adapted according to certain aspects disclosed herein.

FIG. 13 is a flowchart that illustrates certain aspects of a variable-stride write protocol as disclosed herein.

FIG. 14 illustrates an example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a shared communication interface that may include a serial bus or other data communication link to connect processors with modems and other peripherals. The serial bus or data communication link may be operated in accordance with one or more standards or protocols. For example, the serial bus may be operated in accordance with an I2C, I3C, SPMI and/or RFFE protocol, or another protocol that can be configured for half-duplex operation. Increased utilization of serial buses, and/or the imposition of more stringent timing constraints in support of applications, peripherals and sensors can result in demand for reduced transmission latencies. Transmission latency may include the time required to terminate a transaction in process on the serial bus, bus turnaround (between transmit mode and receive mode), bus arbitration and/or command transmissions specified by protocol.

In some implementations, a master device may receive data to be written to different registers in a single device from an application or another device. The data may include high-priority messages or information. In one example, an RFFE interface implemented in a device that includes a fifth generation (5G) radio access technology interface may be required to handle high-priority communication between a master device and non-contiguous registers in a various front-end devices. In conventional implementations, the master device may write contiguous registers in a single transaction. For example, the master device may receive N bytes ordered such that a first byte is to be written to a register at a first address (A₀), a second byte is to be written to a register at the next address (A₀+1), a third byte is to be written to a register at the next address (A₀+2) and so on, up to an Nth byte that is to be written to a register at the address (A₀+N−1). In these conventional implementations, the master device is required to write non-contiguous registers using multiple transactions, and the master device is required to use multiple transactions to write contiguous registers when the data for the contiguous registers is not ordered in sequence of increasing target register address. For example, multiple transactions may be required to write data that arrives at the master device targeted to contiguous registers, but ordered such that the first byte is targeted to a register with a higher address than the last byte.

High bus latency can limit the capabilities and functionality of a serial bus in certain applications. For example, bus latency may limit the number of radio frequency (RF) devices that can be coupled by an I3C, RFFE or SPMI bus. In some examples, multiple serial buses may be implemented to enable RF devices or other low-latency devices to communicate within tight time constraints, including where bus throughput, utilization and/or other operating characteristics are otherwise easily supported by a single bus.

According to certain aspects disclosed herein, bus latency, throughput and other issues may be addressed when data and address pointer offset information are interleaved within a datagram. In one example, a data byte may be followed by a pointer offset used to update an address pointer that selects the current or next register to be written. The address pointer offset information enables non-contiguous register writes using a single datagram.

According to certain aspects disclosed herein, address pointer offset information may be provided within a datagram in which parity bits are repurposed to indicate whether a data byte includes a value to be written to a register or address pointer offset information. A data byte field indicated by a repurposed parity bit as including pointer offset may be used to update an address pointer that selects the current or next register to be written. The address pointer offset information enables non-contiguous register writes using a single datagram where not all data bytes are followed or preceded by an address pointer offset.

Certain aspects disclosed herein may be applicable to a serial bus operated in accordance with an I2C, I3C, SPMI, and/or RFFE protocol, or other protocol. Certain aspects are applicable to a serial bus operated in half-duplex mode or full-duplex mode. Certain aspects are applicable to point-to-point interfaces including UART-based interfaces, line multiplexed UART (LM-UART) interfaces, and virtual GPIO (VGI) and messaging interfaces. Certain aspects are applicable to multipoint interfaces and/or interfaces operated in point-to-point mode.

### Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

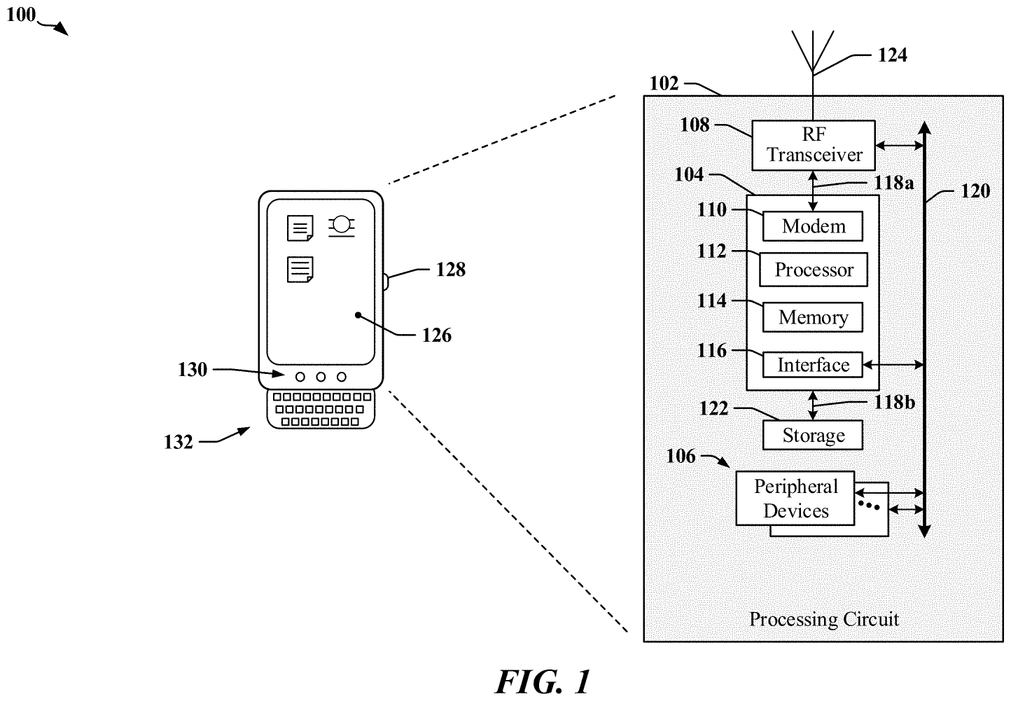

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

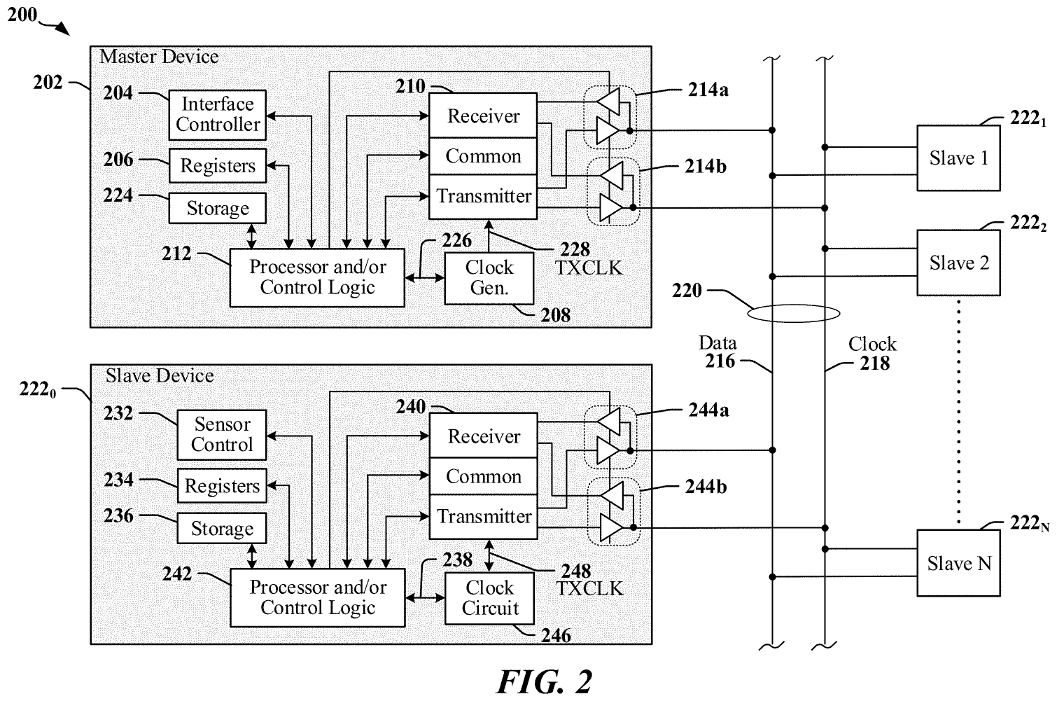

FIG. 2 illustrates certain aspects of an apparatus 200 that includes multiple devices 202, and 222₀-222_{N} coupled to a serial bus 220. The devices 202 and 222₀-222_{N} may be implemented in one or more semiconductor IC devices, such as an applications processor, SoC or ASIC. In various implementations the devices 202 and 222₀-222_{N} may include, support or operate as a modem, a signal processing device, a display driver, a camera, a user interface, a sensor, a sensor controller, a media player, a transceiver, RFFE devices, and/or other such components or devices. In some examples, one or more of the slave devices 222₀-222_{N} may be used to control, manage or monitor a sensor device. Communication between devices 202 and 222₀-222_{N} over the serial bus 220 is controlled by a bus master 202. Certain types of bus can support multiple bus masters 202.

In one example, a master device 202 may include an interface controller 204 that manages access to the serial bus, configures dynamic addresses for slave devices 222₀-222_{N} and/or causes a clock signal 228 to be transmitted on a clock line 218 of the serial bus 220. The master device 202 may include configuration registers 206 or other storage 224, and other control logic 212 configured to handle protocols and/or higher level functions. The control logic 212 may include a processing circuit such as a state machine, sequencer, signal processor or general-purpose processor. The master device 202 includes a transceiver 210 and line drivers/receivers 214a and 214b. The transceiver 210 may include receiver, transmitter and common circuits, where the common circuits may include timing, logic and storage circuits and/or devices. In one example, the transmitter encodes and transmits data based on timing in the clock signal 228 provided by a clock generation circuit 208. Other timing clocks 226 may be used by the control logic 212 and other functions, circuits or modules.

At least one device 222₀-222_{N} may be configured to operate as a slave device on the serial bus 220 and may include circuits and modules that support a display, an image sensor, and/or circuits and modules that control and communicate with one or more sensors that measure environmental conditions. In one example, a slave device 222₀ configured to operate as a slave device may provide a control function, module or circuit 232 that includes circuits and modules to support a display, an image sensor, and/or circuits and modules that control and communicate with one or more sensors that measure environmental conditions. The slave device 222₀ may include configuration registers 234 or other storage 236, control logic 242, a transceiver 240 and line drivers/receivers 244a and 244b. The control logic 242 may include a processing circuit such as a state machine, sequencer, signal processor or general-purpose processor. The transceiver 210 may include receiver, transmitter and common circuits, where the common circuits may include timing, logic and storage circuits and/or devices. In one example, the transmitter encodes and transmits data based on timing in a clock signal 248 provided by clock generation and/or recovery circuits 246. The clock signal 248 may be derived from a signal received from the clock line 218. Other timing clocks 238 may be used by the control logic 242 and other functions, circuits or modules.

The serial bus 220 may be operated in accordance with I2C, I3C, RFFE, SPMI, or another protocol. At least one device 202, 222₀-222_{N} may be configured to selectively operate as either a master device or a slave device on the serial bus 220. Two or more devices 202, 222₀-222_{N} may be configurable to operate as a master device on the serial bus 220.

In some implementations, the serial bus 220 may be operated in accordance with an I3C protocol. Devices that communicate using the I3C protocol can coexist on the same serial bus 220 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 220, in addition to data formats and aspects of bus control. In some aspects, the I2C and I3C protocols may define direct current (DC) characteristics affecting certain signal levels associated with the serial bus 220, and/or alternating current (AC) characteristics affecting certain timing aspects of signals transmitted on the serial bus 220. In some examples, a 2-wire serial bus 220 transmits data on a data line 216 and a clock signal on the clock line 218. In some instances, data may be encoded in the signaling state, or transitions in signaling state of the data line 216 and the clock line 218.

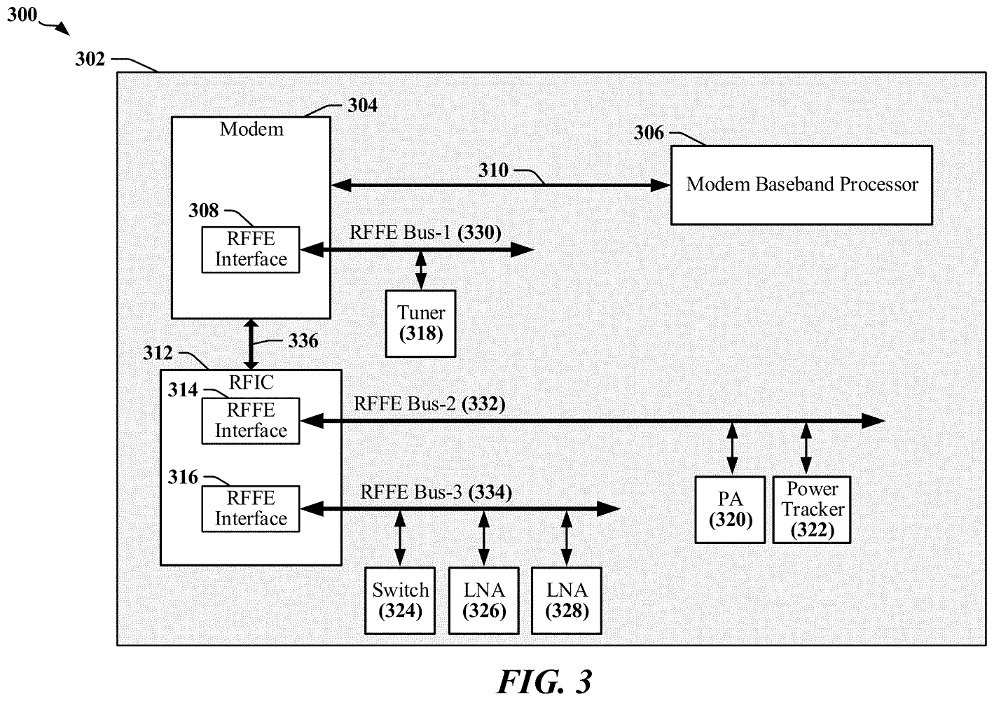

FIG. 3 is a diagram 300 illustrating an example of a configuration of communication links in a chipset or device 302 that employs multiple RFFE buses 330, 332, 334 to couple various RF front-end devices 318, 320, 322, 324, 326 328. In this example, a modem 304 includes an RFFE interface 308 that couples the modem 304 to a first RFFE bus 330. The modem 304 may communicate with a baseband processor 306 and a Radio-Frequency IC (RFIC 312) through respective communication links 310, 336 or, in some implementations, through a common communication link 310 or 336. The illustrated device 302 may be embodied in one or more of a mobile communication device, a mobile telephone, a mobile computing system, a mobile telephone, a notebook computer, a tablet computing device, a media player, a gaming device, a wearable computing device, a wearable communication device, an appliance, or the like.

In various examples, the device 302 may be implemented with one or more baseband processors 306, modems 304, RFICs 312, multiple communication links 310, 336, multiple RFFE buses 330, 332, 334 and/or other types of buses. The device 302 may include other processors, circuits, modules and may be configured for various operations and/or different functionalities. In the example illustrated in FIG. 3, the modem 304 is coupled to an RF tuner 318 through its RFFE interface 308 and the first RFFE bus 330. The RFIC 312 may include one or more RFFE interfaces 314, 316, controllers, state machines and/or processors that configure and control certain aspects of the RF front-end. In the illustrated example, the RFIC 312 communicates with a PA 320 and a power tracking module 322 through a first of its RFFE interfaces 314 and the second RFFE bus 332. In the illustrated example, RFIC 312 communicates with a switch 324 and one or more LNAs 326, 328 through a second of its RFFE interfaces 316 and the third RFFE bus 334.

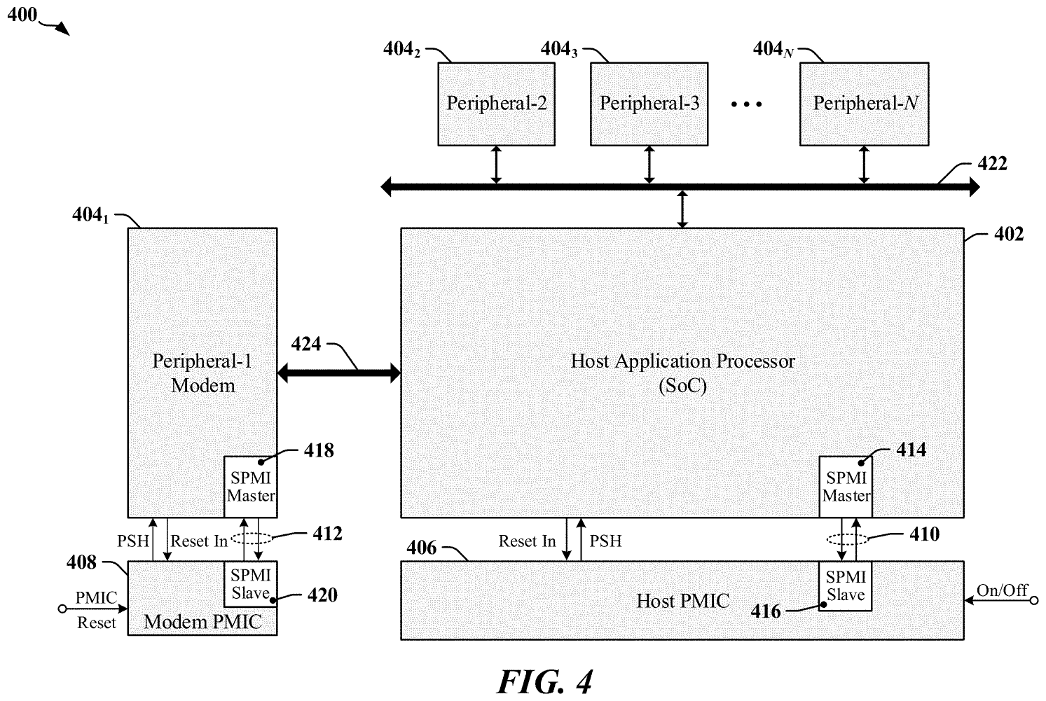

The MIPI Alliance system power management interface (SPMI) specifies a hardware interface that may be implemented between baseband or application processors and peripheral components to support a variety of data communication functions including data communication related to power management operations. FIG. 4 illustrates an example of a system 400 which includes data communication links 410, 412, where each of the data communication links 410, 412 is configured as a two-wire serial bus operated in accordance with SPMI protocols. In one example, a first data communication link 410 may be used to connect an integrated power controller of an application processor 402 with a voltage regulation system in a first power management integrated circuit (PMIC 406), and a second data communication link 412 may be used to connect an integrated power controller of a modem 404₁ with a voltage regulation system in a second PMIC 408. The data communication links 410, 412 can be used to accurately monitor and control processor performance levels required for a given workload or application and dynamically control the various supply voltages in real time based on the performance levels. The data communication links 410, 412 can be used to carry other types of data between the application processor 402 and the first PMIC 406 and/or between the modem 404₁ and the second PMIC 408. SPMI protocols provide for multi-drop serial links that can connect a variety of different devices and carry a variety of data types, including data types used for power management. Some SPMI data communication links may be optimized for real-time power management functions. Some SPMI data communication links may be used as a shared bus that provides high-speed, low-latency connection for devices where data transmissions may be managed, according to priorities assigned to different traffic classes.

In the system 400 illustrated in FIG. 4, the application processor 402 that may serve as a host device on various data communication links 410, 422, 424 that couple multiple peripherals 404₁-404_{N} to the application processor 402. The application processor 402 and the modem 404₁ may be coupled to respective PMICs 406, 408 through data communication links 410, 412 operated in accordance with SPMI protocols and controlled by SPMI masters 414, 418. The SPMI masters 414, 418 communicate with corresponding SPMI slaves 416, 420 provided in the PMICs 406, 408, and facilitate real-time management and control of the PMICs 406, 408. The application processor 402 may be coupled to the peripherals 404₁-404_{N} using same or different types of data communication links 422, 424. In various implementations, the data communication links 422, 424 are operated in accordance RFFE, SPMI, and/or I3C protocols.

Bus latency can affect the ability of a serial bus to handle high-priority, real-time and/or other time-constrained messages. Low-latency messages, or messages requiring low bus latency, may relate to sensor status, device-generated real-time events and virtualized general-purpose input/output (GPIO). In one example, bus latency can be measured as the time elapsed between a message becoming available for transmission and the delivery of the message. In another example, bus latency can be measured as the time elapsed between a message becoming available for transmission and commencement of transmission of the message. Other measures of bus latency may be employed. Bus latency typically includes delays incurred while higher priority messages are transmitted, interrupt processing, the time required to terminate a datagram in process on the serial bus, the time to transmit commands causing bus turnaround between transmit mode and receive mode, bus arbitration and/or command transmissions specified by protocol.

Bus latency may be reduced by decreasing the overhead associated with transmitting data over a multi-drop serial bus. The overhead may include control signaling such as the start and stop transmissions in I3C protocols, the sequence start condition (SSC) and bus park cycle (BPC) in SPMI and/or RFFE protocols, slave address fields, command codes, and register address fields. Overhead may also be reduced by writing data in fewer datagrams.

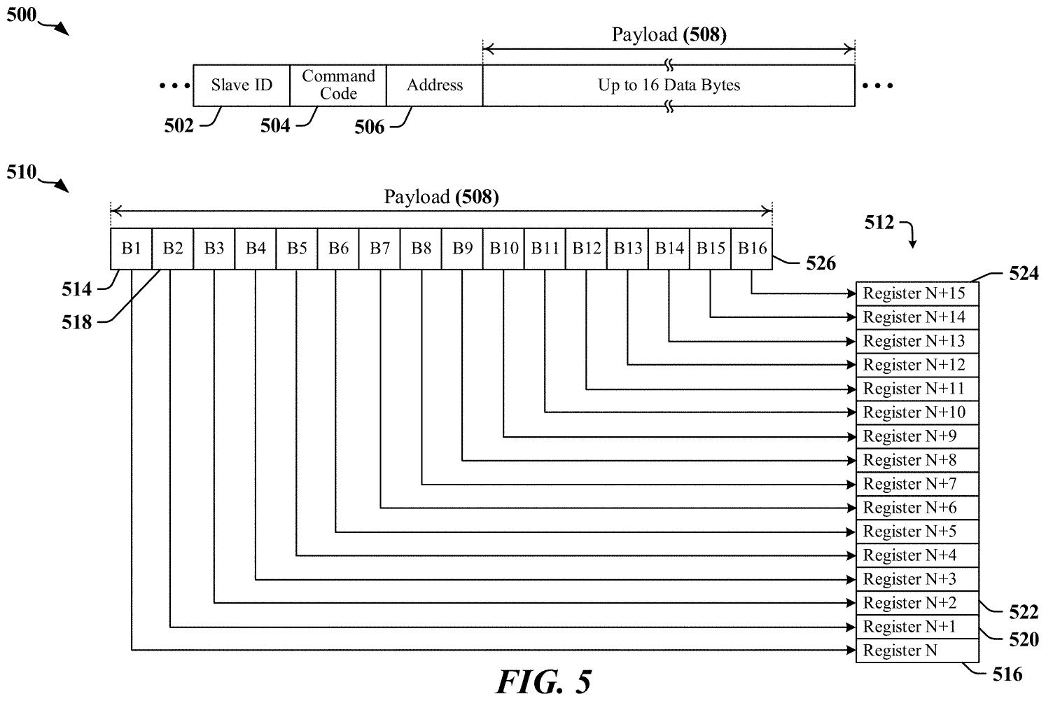

FIG. 5 illustrates certain aspects of a generalized datagram 500 that may be transmitted over a multi-drop serial bus. Control transmissions specific to bus protocols (not shown in the generalized datagram 500) also contribute to bus latency. The generalized datagram 500 may be a slave write datagram and includes a slave identifier field 502 used to identify one or more slave devices to receive the payload 508. A command code field 504 can be included to specify the type of datagram and/or operation to be performed, and a register address field defines the address of the first register to be written. The generalized datagram 500 is used to communicate a payload 508 that may include data, virtualized GPIO, control information, coexistence messages and/or other types of information. The illustrated payload 508 includes up to 16 bytes to be written to contiguous registers within the address space of a slave device commencing at the address provided in the register address field 506.

The configuration and bit-size of the fields 502, 504 and 506 may vary based on the protocol used to control bus operations in an implementation. In one example, the command code field 504 may indicate the RFFE/SPMI Extended Register Write Long command and the register address field 506 may include a 16-bit address field to enable data to be written within a 64 kilobyte register space or address space in a slave device. In another example, the command code field 504 may indicate the RFFE/SPMI Extended Register Write command and the register address field 506 may include an 8-bit address field to enable data to be written within a 256 byte register space or address space in a slave device.

Different protocols may define different bit-sizes for the slave identifier field 502. The size and meaning of the command code field 504 may be protocol-specific, although certain protocols (e.g. SPMI and RFFE) may provide the same or similar structures for datagrams and the same or similar command codes in the command code field 504.

According to conventional protocols, data in the payload 508 is written to a block of contiguous registers 512. For example, a 16-byte payload 508 may be written to a block of contiguous registers 512 that include 16 registers located at consecutive addresses. The address of the first register 516 in the block of contiguous registers 512 is defined in the register address field 506 and may be used to initialize a write pointer. The first byte 514 in the payload 508 is written to the first register 516 and the write pointer is incremented to point to the second register 520 in the block of contiguous registers 512. The second byte 518 in the payload 508 is written to the second register 520 and the write pointer is incremented to point to the third register 522 in the block of contiguous registers 512. The remaining bytes in the payload 508 are consecutively written to the block of contiguous registers 512 until the last byte 526 in the payload 508 is written to the sixteenth register 524 in the block of contiguous registers 512.

Conventional implementations of RFFE, SPMI, I3C and other serial protocols specify a write operation that is rigidly fixed and directed to contiguous locations commencing at an initial address specified by the register address field 506. Applications such as 5G radios produce greater volumes of data to be transferred between devices and often result in the generation of data to be written to non-contiguous registers in slave devices. The need to perform multiple write transactions to handle non-contiguous writes can increase latency in applications where lower latencies are required.

According to certain aspects of this disclosure, a single datagram can be transmitted in a manner that enables a slave device to write included data to indicated non-contiguous registers. In some aspects, a variable-stride write (VSW) capability is provided that enables a write pointer in the slave device to be adjusted in a non-incremental manner.

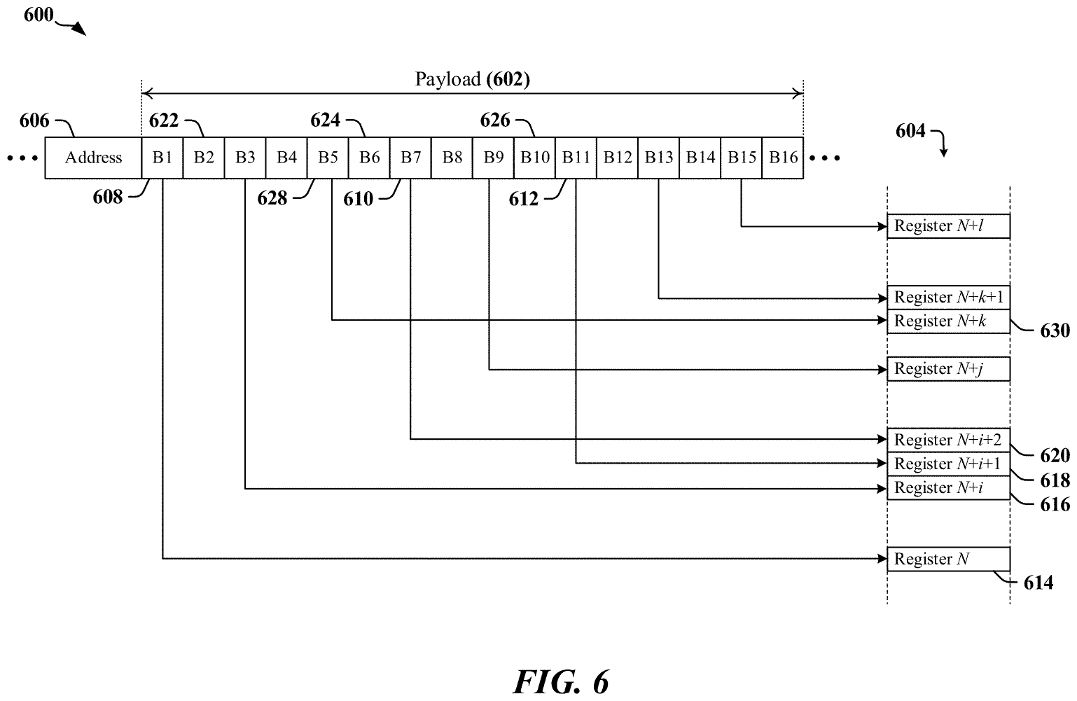

FIG. 6 illustrates an example of a VSW datagram 600 that enables data to be written to non-contiguous registers in a block of contiguous registers 604. In this example, up to eight data bytes can be transmitted in a payload 602, together with variable stride or address offset information. In the illustrated example, a first data byte 608 is written to first register 614 (Register N) located at an address specified by the register address field 606 provided in the VSW datagram 600. In some examples, the register address field 606 may be used to initialize a write address pointer. The next byte 622 in the VSW datagram 600 provides a stride value (i) that is used to adjust the write address pointer to point to the next register 616 (Register N+i). The stride value can be positive or negative. For example, the third and fifth stride values carried by the sixth byte 624 and the tenth byte 626 in the payload 602, respectively, are negative numbers that cause the address pointer to move backwards in the block of contiguous registers 604. In one example, the third data byte 628 in the payload 602 is written to a register 630 at an address that is greater than the address of the register 620 to which the fourth data byte 610 in the payload 602 is written. In one example, the sixth data byte 612 in the payload 602 is written to a register 618 at an address that is lower than the address of the register to which the fifth data byte in the payload 602 is written.

In the example illustrated in FIG. 6, each of the eight data bytes in the payload 602 is written to a register that is non-contiguous with respect to the register receiving the immediately preceding data byte. In a conventional system, eight separate datagrams would be required to write the eight data bytes, where each datagram carries an overhead calculated as the combined number of bits in the start and stop signaling, the slave identifier, the command code and the register address field. In the example illustrated in FIG. 6, the use of the VSW datagram 600 significantly reduces bus latency by eliminating the protocol overhead for 7 datagrams.

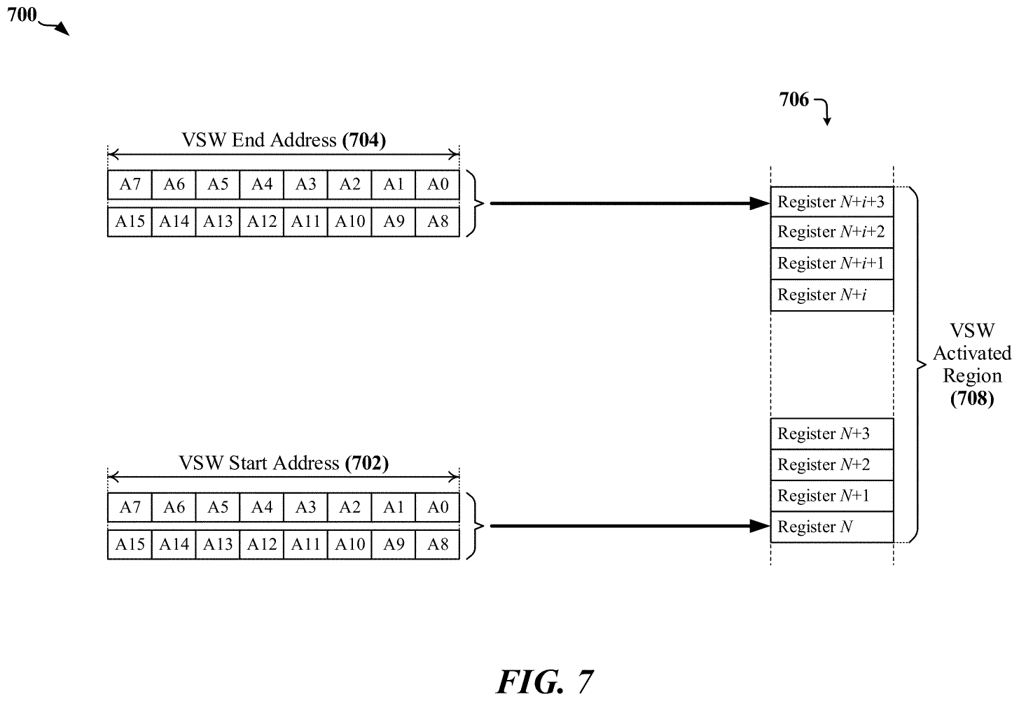

According to certain aspects disclosed herein, VSW may be selectively enabled within a slave device. FIG. 7 illustrates one example of a selective VSW implementation 700, where write commands addressed to a starting register within a portion of the address space in a slave device may be treated as VSW write command. No changes to bus protocols are necessary when VSW operation is activated within a marked subset of the register address space.

The subset of the register address space subject to VSW writes (the active VSW region 708) may be marked using address pointers 702, 704. A slave device may be equipped with a block of registers 706 that are addressable by a master device over the serial bus. In the illustrated example, the block of registers 706 may occupy an address space sufficient to support 64 kilobytes of data. The slave device may maintain a 16-bit VSW start address pointer 702 and a 16-bit VSW end address pointer 704 that define the active VSW region 708 in the address space. A write command addressed to a first register that lies within the active VSW region 708 in the address space is treated as a VSW write command. A write command addressed to a first register that lies outside the active VSW region 708 in the address space is treated as a conventional register write command.

In one example, the 16-bit VSW start address pointer 702 and the 16-bit VSW end address pointer 704 may be stored in pairs of registers in the block of registers 706. In other examples, the 16-bit VSW start address pointer 702 and the 16-bit VSW end address pointer 704 may be maintained in local registers of a finite state machine or another processor that manages communication over the serial bus.

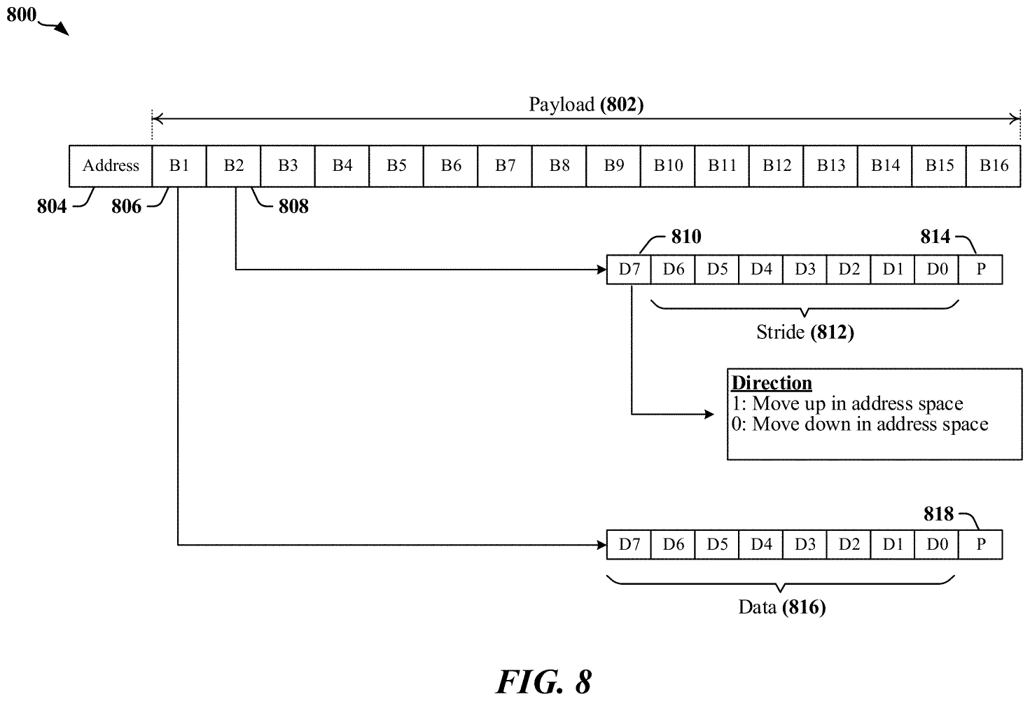

FIG. 8 illustrates certain additional aspects of a VSW datagram 800, which may correspond to the VSW datagram 600 illustrated in FIG. 6. The VSW datagram 800 includes a register address field 804 indicating the register address to which the first data byte 806 of the payload 802 is to be written. The first data byte 806 may include eight data bits 816 and a parity bit 818. The second byte 808 of the payload 802 may include a stride value 812, a direction bit 810 and a parity bit 814. The stride value 812 indicates an offset from the current write address to the next write address. The direction bit 810 indicates whether the stride value 812 should be added to the current write address or subtracted from the current write address.

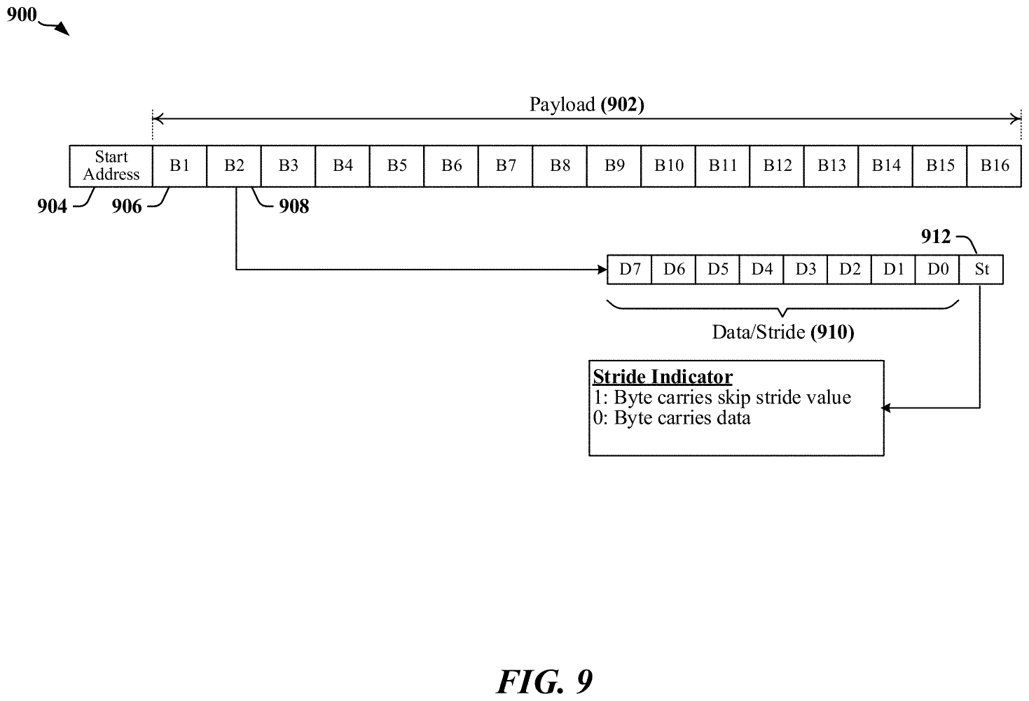

In some implementations, VSW write may involve single direction variable strides. In these implementations, a datagram may be configured to carry more data bytes than the VSW implementation illustrated in FIGS. 6 and 8. For example, FIG. 9 illustrates a VSW datagram 800 that allocates bytes to carry stride values only when the next byte is to be written to a non-contiguous register. In this example, the parity bit of each data byte is repurposed to indicate whether the data byte includes a register value or a stride value. The parity bit is typically repurposed only in the active VSW region or when the slave device receives a write command that explicitly indicates that the write command is a VSW write command.

The VSW datagram 900 includes a register address field 904 indicating the register address to which the first data byte 906 of the payload 902 is to be written. When the register address field 904 indicates an address within the active VSW region or the write command is an explicit VSW command, the slave device may discontinue parity processing for the VSW datagram 900 and treat the parity bit 912 as a stride indicator. For example, the content 910 of the second data byte 908 in the payload 902 may include a register value or a stride value. When set to zero, the stride indicator (repurposed parity bit 912) may indicate that the data byte 908 contains a register value. When set to one, the stride indicator (repurposed parity bit 912) may indicate that the data byte 908 is a stride value used to offset the current write address. When the data byte 908 contains a register value, the current write address is incremented after the data byte is written.

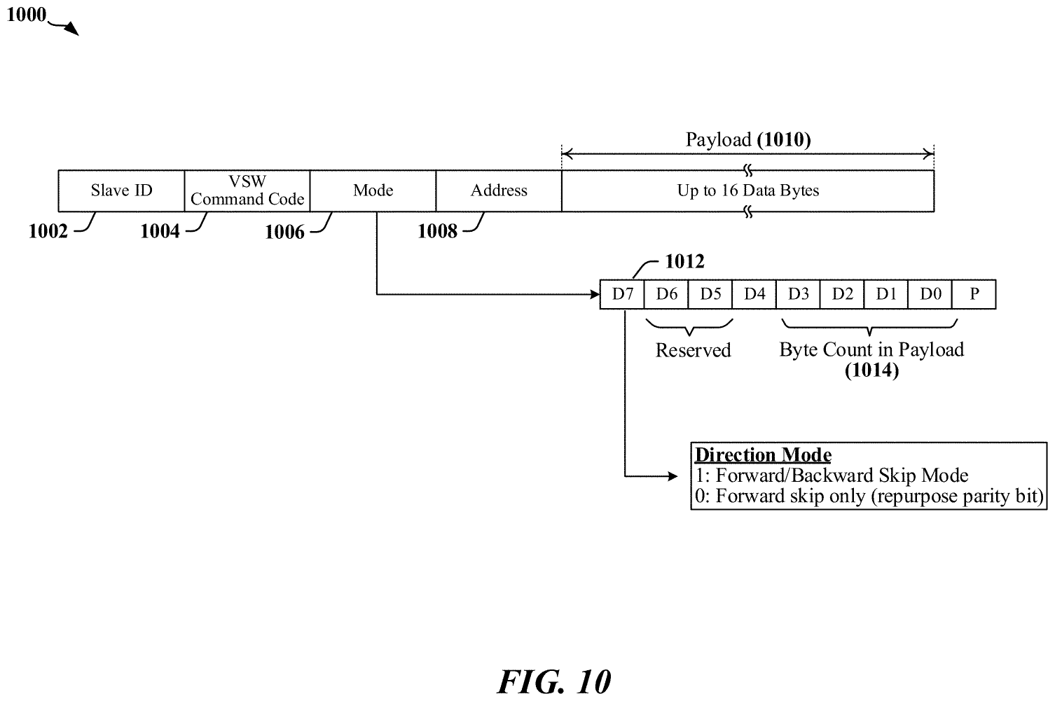

FIG. 10 illustrates a VSW datagram 1000 that includes an explicit VSW command code 1004. The VSW datagram 1000 includes a slave identifier 1002 followed by the VSW command code 1004 and mode information 1006. The mode information 1006 may define the type of VSW operation to be performed and other information. One bit 1012 of the mode information 1006 may select between the forward/backward skip mode illustrated in FIGS. 6 and 8, and the limited, forward skip mode illustrated in FIG. 9 that uses a repurposed parity bit 912. The mode information 1006 may also include a field 1014 that identifies the number of data bytes to be transmitted in the payload 1010. A register address field 1008 provided in the VSW datagram 1000 identifies the address of the first register to be written. The register address field 1008 may be used to initialize a write address pointer.

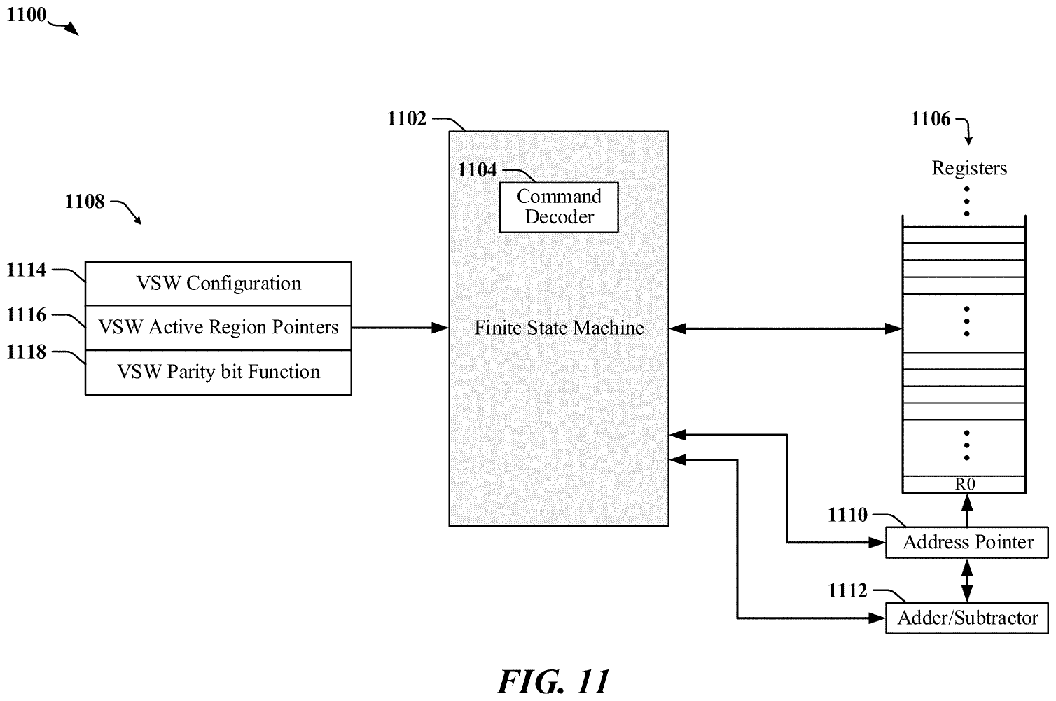

FIG. 11 illustrates a circuit 1100 that may be included in a serial interface to implement VSW. The circuit 1100 may include a finite state machine 1102 that includes or implements a command decoder 1104 configured for a protocol that manages communication over the serial bus. The command decoder 1104 may be adapted to handle explicit VSW command codes. The finite state machine 1102 may be configured through configuration registers 1108. The configuration registers 1108 may include one or more registers 1114 that maintain general VSW configuration, including whether VSW is enabled, size of address space, size of data payloads and so on. The configuration registers 1108 may include one or more region registers 1116 that identify the VSW active region of the register address space. In one example, the region registers 1116 correspond to, or include the VSW start address pointer 702 and the 16-bit VSW end address pointer 704 illustrated in FIG. 7. The configuration registers 1108 may include one or more function registers 1118 that identify the function of the parity bits in payload data. For example, the one or more function registers 1118 may indicate when the parity bit is repurposed, including in the VSW active region of the register address space.

The finite state machine 1102 may be configured to control access to a block of registers 1106 during VSW operations. The finite state machine 1102 may operate or control an address pointer 1110 that can be implemented as a programmable counter, for example. In conventional modes of operation, the finite state machine 1102 may cause the address pointer to be incremented after a register is written. In VSW modes of operation, the finite state machine 1102 may cause the address pointer to be modified by a stride value received in a datagram. In one example, the finite state machine 1102 may cause an adder/subtractor 1112 to add the stride value to the address pointer when forward strides are indicated by the payload data. In another example, the finite state machine 1102 may cause the adder/subtractor 1112 to subtract the stride value from the address pointer when backward strides are indicated by the payload data.

### Examples of Processing Circuits and Methods

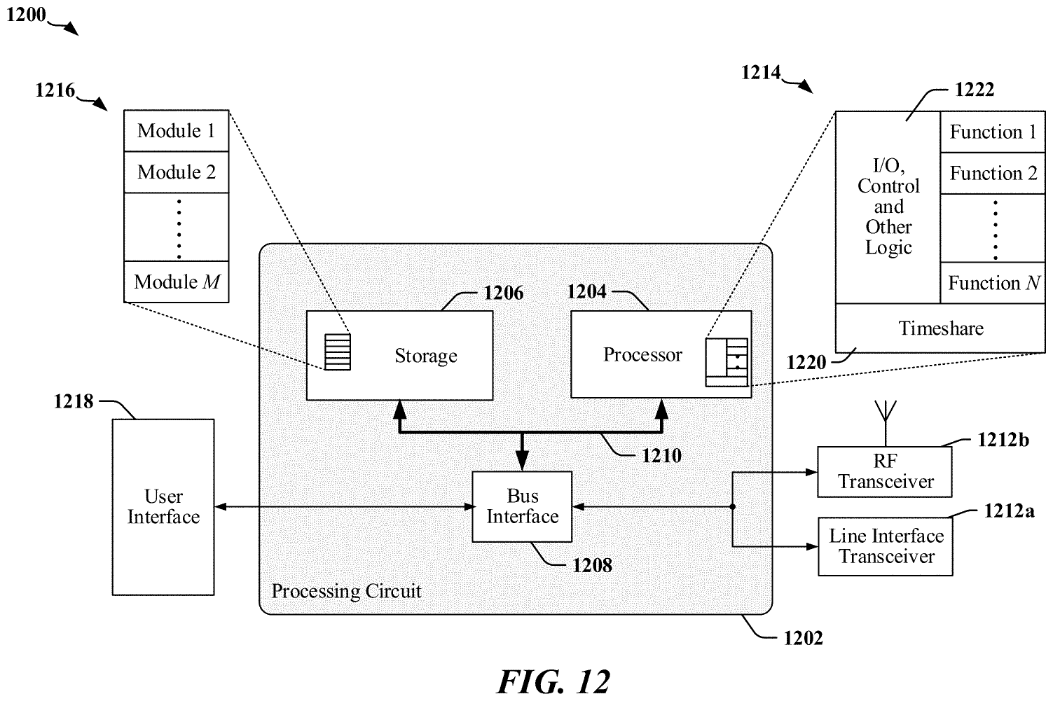

FIG. 12 is a diagram illustrating an example of a hardware implementation for an apparatus 1200. In some examples, the apparatus 1200 may perform one or more functions disclosed herein. In accordance with various aspects of the disclosure, an element, or any portion of an element, or any combination of elements as disclosed herein may be implemented using a processing circuit 1202. The processing circuit 1202 may include one or more processors 1204 that are controlled by some combination of hardware and software modules. Examples of processors 1204 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1204 may include specialized processors that perform specific functions, and that may be configured, augmented or controlled by one of the software modules 1216. The one or more processors 1204 may be configured through a combination of software modules 1216 loaded during initialization, and further configured by loading or unloading one or more software modules 1216 during operation.

In the illustrated example, the processing circuit 1202 may be implemented with a bus architecture, represented generally by the bus 1210. The bus 1210 may include any number of interconnecting buses and bridges depending on the specific application of the processing circuit 1202 and the overall design constraints. The bus 1210 links together various circuits including the one or more processors 1204, and storage 1206. Storage 1206 may include memory devices and mass storage devices, and may be referred to herein as computer-readable media and/or processor-readable media. The bus 1210 may also link various other circuits such as timing sources, timers, peripherals, voltage regulators, and power management circuits. A bus interface 1208 may provide an interface between the bus 1210 and one or more transceivers 1212a, 1212b. A transceiver 1212a, 1212b may be provided for each networking technology supported by the processing circuit. In some instances, multiple networking technologies may share some or all of the circuitry or processing modules found in a transceiver 1212a, 1212b. Each transceiver 1212a, 1212b provides a means for communicating with various other apparatus over a transmission medium. In one example, a transceiver 1212a may be used to couple the apparatus 1200 to a multi-wire bus. In another example, a transceiver 1212b may be used to connect the apparatus 1200 to a radio access network. Depending upon the nature of the apparatus 1200, a user interface 1218 (e.g., keypad, display, speaker, microphone, joystick) may also be provided, and may be communicatively coupled to the bus 1210 directly or through the bus interface 1208.

A processor 1204 may be responsible for managing the bus 1210 and for general processing that may include the execution of software stored in a computer-readable medium that may include the storage 1206. In this respect, the processing circuit 1202, including the processor 1204, may be used to implement any of the methods, functions and techniques disclosed herein. The storage 1206 may be used for storing data that is manipulated by the processor 1204 when executing software, and the software may be configured to implement any one of the methods disclosed herein.

One or more processors 1204 in the processing circuit 1202 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1206 or in an external computer-readable medium. The external computer-readable medium and/or storage 1206 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1206 may also include, by way of example, a carrier wave, a transmission line, and any other suitable medium for transmitting software and/or instructions that may be accessed and read by a computer. Computer-readable medium and/or the storage 1206 may reside in the processing circuit 1202, in the processor 1204, external to the processing circuit 1202, or be distributed across multiple entities including the processing circuit 1202. The computer-readable medium and/or storage 1206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1206 may maintain software maintained and/or organized in loadable code segments, modules, applications, programs, etc., which may be referred to herein as software modules 1216. Each of the software modules 1216 may include instructions and data that, when installed or loaded on the processing circuit 1202 and executed by the one or more processors 1204, contribute to a run-time image 1214 that controls the operation of the one or more processors 1204. When executed, certain instructions may cause the processing circuit 1202 to perform functions in accordance with certain methods, algorithms and processes described herein.

Some of the software modules 1216 may be loaded during initialization of the processing circuit 1202, and these software modules 1216 may configure the processing circuit 1202 to enable performance of the various functions disclosed herein. For example, some software modules 1216 may configure internal devices and/or logic circuits 1222 of the processor 1204, and may manage access to external devices such as a transceiver 1212a, 1212b, the bus interface 1208, the user interface 1218, timers, mathematical coprocessors, and so on. The software modules 1216 may include a control program and/or an operating system that interacts with interrupt handlers and device drivers, and that controls access to various resources provided by the processing circuit 1202. The resources may include memory, processing time, access to a transceiver 1212a, 1212b, the user interface 1218, and so on.

One or more processors 1204 of the processing circuit 1202 may be multifunctional, whereby some of the software modules 1216 are loaded and configured to perform different functions or different instances of the same function. The one or more processors 1204 may additionally be adapted to manage background tasks initiated in response to inputs from the user interface 1218, the transceiver 1212a, 1212b, and device drivers, for example. To support the performance of multiple functions, the one or more processors 1204 may be configured to provide a multitasking environment, whereby each of a plurality of functions is implemented as a set of tasks serviced by the one or more processors 1204 as needed or desired. In one example, the multitasking environment may be implemented using a timesharing program 1220 that passes control of a processor 1204 between different tasks, whereby each task returns control of the one or more processors 1204 to the timesharing program 1220 upon completion of any outstanding operations and/or in response to an input such as an interrupt. When a task has control of the one or more processors 1204, the processing circuit is effectively specialized for the purposes addressed by the function associated with the controlling task. The timesharing program 1220 may include an operating system, a main loop that transfers control on a round-robin basis, a function that allocates control of the one or more processors 1204 in accordance with a prioritization of the functions, and/or an interrupt driven main loop that responds to external events by providing control of the one or more processors 1204 to a handling function.

Methods for optimizing virtual GPIO latency may include an act of parsing various input sources including sources of GPIO signal state, parameters and/or messages to be transmitted. The input sources may include hardware events, configuration data, mask parameters, and register addresses. Packet-specific latency estimators may be employed to estimate the latency for corresponding packet types based upon the parsed parameters. A packet type to be used for transmission may be selected based on the minimum latency calculated or determined for available packet types. The selected packet type may be identified using a command code, which may be provided to a packetizer with a payload to be transmitted. The command code may also reflect a protocol to be used to transmit the payload. In some implementations, the physical link used to transmit the payload may be operated according to different protocols or different variants of one or more protocols. The protocol to be used for transmitting the payload may be selected based on latencies associated with the various available protocols or variants of protocols.

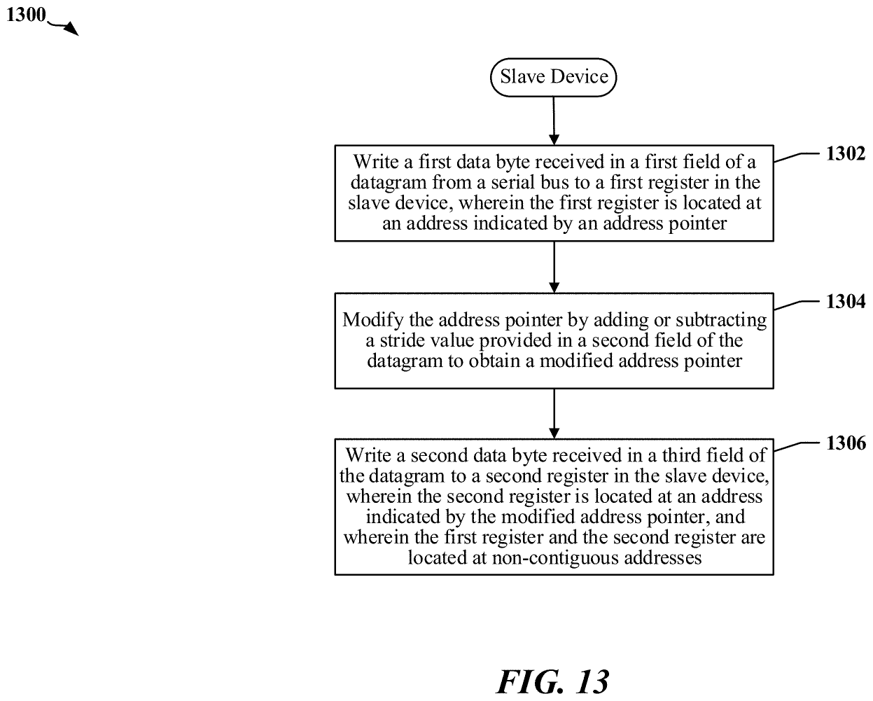

FIG. 13 is a flowchart 1300 of a method that may be performed by a slave device coupled to a serial bus. The serial bus may be operated in accordance with an I3C, RFFE, SPMI protocol or another protocol.

At block 1302, the slave device may write a first data byte received in a first field of a datagram from a serial bus to a first register in the slave device. The first register may be located at an address indicated by an address pointer. At block 1304, the slave device may modify the address pointer by adding or subtracting a stride value provided in a second field of the datagram to obtain a modified address pointer. At block 1306, the slave device may write a second data byte received in a third field of the datagram to a second register in the slave device. The second register may be located at an address indicated by the modified address pointer. The first register and the second register may be located at non-contiguous addresses. The second field may include a bit indicating whether the stride value is to be added to the address pointer or subtracted from the address pointer. The

In certain implementations, the datagram includes a stride value that is interleaved between fields carrying a pair of data bytes to be written to non-contiguous registers in the slave device. The datagram may include a register address that serves as an initial address pointer. One or more stride values may be provided in the datagram when the initial address pointer indicates an address within an active variable-stride write region. The active variable-stride write region may be defined by a start address pointer and an end address pointer stored in the slave device.

In some examples, a parity bit of the first field is set to a first value indicating that the first data byte is to be written to the first register. A parity bit of the second field may be set to a second value indicating that the second field carries the stride value. The address pointer may be modified by adding the stride value to the address pointer. The datagram may include a register address that serves as an initial address pointer. Parity bits in the datagram may be repurposed to distinguish between register write data and stride values when the initial address pointer indicates an address within an active variable-stride write region. The active variable-stride write region may be defined by registers in the slave device that are configured with a start address pointer and an end address pointer.

In certain implementations, the slave device receives a command code in the datagram, and may enable a variable-stride write mode in response to the command code. The variable-stride write mode may be indicated in mode information received in the datagram. In one example, the mode information defines whether parity bits in the datagram distinguish between register write data and stride values. In another example, the mode information defines whether the address pointer is to be modified by subtracting the stride value.

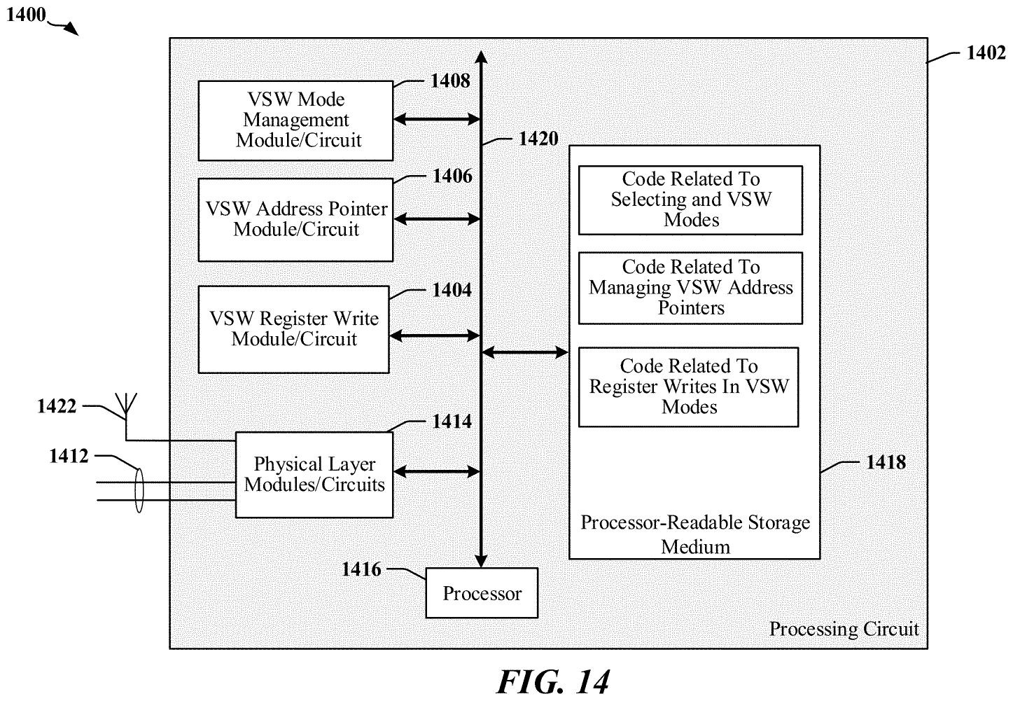

FIG. 14 is a diagram illustrating a simplified example of a hardware implementation for an apparatus 1400 employing a processing circuit 1402. The processing circuit typically has a controller or processor 1416 that may include one or more microprocessors, microcontrollers, digital signal processors, sequencers and/or state machines. The processing circuit 1402 may be implemented with a bus architecture, represented generally by the bus 1420. The bus 1420 may include any number of interconnecting buses and bridges depending on the specific application of the processing circuit 1402 and the overall design constraints. The bus 1420 links together various circuits including one or more processors and/or hardware modules, represented by the controller or processor 1416, the modules or circuits 1404, 1406 and 1408 and the processor-readable storage medium 1418. One or more physical layer circuits and/or modules 1414 may be provided to support communication over a communication link implemented using a multi-wire bus 1412, through an antenna 1422 (to a radio access network for example), and so on. The bus 1420 may also link various other circuits such as timing sources, peripherals, voltage regulators, and power management circuits, which are well known in the art, and therefore, will not be described any further.

The processor 1416 is responsible for general processing, including the execution of software, code and/or instructions stored on the processor-readable storage medium 1418. The processor-readable storage medium may include a non-transitory storage medium. The software, when executed by the processor 1416, causes the processing circuit 1402 to perform the various functions described supra for any particular apparatus. The processor-readable storage medium 1418 may be used for storing data that is manipulated by the processor 1416 when executing software. The processing circuit 1402 further includes at least one of the modules 1404, 1406 and 1408. The modules 1404, 1406 and 1408 may be software modules running in the processor 1416, resident/stored in the processor-readable storage medium 1418, one or more hardware modules coupled to the processor 1416, or some combination thereof. The modules 1404, 1406 and 1408 may include microcontroller instructions, state machine configuration parameters, or some combination thereof.

In one configuration, the apparatus 1400 includes modules and/or circuits 1408 adapted to configure the apparatus 1400 for one or more VSW modes. The apparatus 1400 may include modules and/or circuits 1406 adapted to manage an address pointer when the apparatus is operated in a VSW mode, where the modules and/or circuits 1406 are operable to cause the address pointer to increase or decrease by variable offsets defined in a VSW datagram. The apparatus 1400 may include modules and/or circuits 1404 adapted to write registers at addresses defined by an address pointer operated in a VSW mode.

In one example, the apparatus 1400 includes or operates as a slave device that has various addressable registers. The physical layer circuits and/or modules 1414 of the apparatus 1400 may implement an interface circuit adapted to couple the apparatus 1400 to the multi-wire bus 1412. The apparatus 1400 may have a finite state machine or other processor 1416 that is configured to cause a first data byte received in a first field of a datagram received from the multi-wire bus 1412 to be written to a first register, cause the address pointer to be modified by addition or subtraction of a stride value provided in a second field of the datagram to obtain a modified address pointer, and cause a second data byte received in a third field of the datagram to be written to a second register in the apparatus. The first register may be located at an address indicated by an address pointer. The second register may be located at an address indicated by the modified address pointer. The first register and the second register may be located at non-contiguous addresses. The second field may include a bit indicating whether the stride value is to be added to the address pointer or subtracted from the address pointer.

In certain implementations, the datagram includes a stride value that is interleaved between fields carrying a pair of data bytes to be written to non-contiguous registers in the slave device. The datagram may include a register address that serves as an initial address pointer. One or more stride values may be provided in the datagram when the initial address pointer indicates an address within an active variable-stride write region. The active variable-stride write region may be defined by a start address pointer and an end address pointer stored in two or more of the plurality of registers.

In some examples, a parity bit of the first field is set to a first value indicating that the first data byte is to be written to the first register, and a parity bit of the second field is set to a second value indicating that the second field carries the stride value. The address pointer may be modified by adding the stride value to the address pointer. The datagram may include a register address that serves as an initial address pointer. Parity bits in the datagram may be configured to distinguish between register write data and stride values when the initial address pointer indicates an address within an active variable-stride write region. The active variable-stride write region is defined by a start address pointer and an end address pointer stored in two or more of the plurality of registers.

In some implementations, the processor 1416 is further configured to receive a command code from the datagram, and enable a variable-stride write mode in response to the command code. The variable-stride write mode may be indicated in mode information provided in the datagram. The mode information may define whether parity bits in the datagram distinguish between register write data and stride values. The mode information may define whether the address pointer can be modified by subtracting the stride value.

In another example, the processor-readable storage medium 1418 stores or maintains one or more instructions which, when executed by the state machine or a processor 1416 of the processing circuit 1402, cause the processing circuit 1402 to write a first data byte received in a first field of a datagram from a serial bus to a first register in the slave device, modify the address pointer by adding or subtracting a stride value provided in a second field of the datagram to obtain a modified address pointer, and write a second data byte received in a third field of the datagram to a second register in the slave device. The first register may be located at an address indicated by an address pointer and the second register may be located at an address indicated by the modified address pointer. The first register and the second register may be located at non-contiguous addresses. The second field may include a bit indicating whether the stride value is to be added to the address pointer or subtracted from the address pointer.

In one example, the datagram includes a stride value that is interleaved between fields carrying a pair of data bytes to be written to non-contiguous registers in the slave device. The datagram may include or carry a register address that serves as an initial address pointer. One or more stride values may be provided in the datagram when the initial address pointer indicates an address within an active variable-stride write region. The active variable-stride write region may be defined by a start address pointer and an end address pointer stored in the slave device.

In certain examples, a parity bit of the first field is set to a first value indicating that the first data byte is to be written to the first register, and a parity bit of the second field is set to a second value indicating that the second field carries the stride value. The address pointer may be modified by adding the stride value to the address pointer. The datagram may include a register address that serves as an initial address pointer. Parity bits in the datagram may be configured to distinguish between register write data and stride values when the initial address pointer indicates an address within an active variable-stride write region. The active variable-stride write region may be defined by registers configured with a start address pointer and an end address pointer stored in the slave device.

In some examples, the processor-readable storage medium 1418 stores or maintains one or more instructions that cause the processing circuit 1002 to receive a command code in the datagram, and enable a variable-stride write mode in response to the command code. The variable-stride write mode may be indicated in mode information received in the datagram. The mode information may define whether parity bits in the datagram distinguish between register write data and stride values. The mode information may define whether the address pointer is to be modified by subtracting the stride value.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method of data communication at a slave device, comprising:
writing a first data byte received in a first field of a datagram from a serial bus to a first register in the slave device, wherein the first register is located at an address indicated by an address pointer;
modifying the address pointer by adding or subtracting a stride value provided in a second field of the datagram to obtain a modified address pointer; and
writing a second data byte received in a third field of the datagram to a second register in the slave device, wherein the second register is located at an address indicated by the modified address pointer, and wherein the first register and the second register are located at non-contiguous addresses.

2. The method of claim 1, wherein the second field includes a bit indicating whether the stride value is to be added to the address pointer or subtracted from the address pointer.

3. The method of claim 1, wherein the datagram comprises a stride value that is interleaved between fields carrying a pair of data bytes to be written to non-contiguous registers in the slave device.

4. The method of claim 3, wherein the datagram includes a register address that serves as an initial address pointer, and wherein one or more stride values are provided in the datagram when the initial address pointer indicates an address within an active variable-stride write region.

5. The method of claim 4, wherein the active variable-stride write region is defined by a start address pointer and an end address pointer stored in the slave device.

6. The method of claim 1, wherein a parity bit of the first field is set to a first value indicating that the first data byte is to be written to the first register, and a parity bit of the second field is set to a second value indicating that the second field carries the stride value.

7. The method of claim 6, wherein the address pointer is modified by adding the stride value to the address pointer.

8. The method of claim 6, wherein the datagram includes a register address that serves as an initial address pointer, and wherein parity bits in the datagram are configured to distinguish between register write data and stride values when the initial address pointer indicates an address within an active variable-stride write region.

9. The method of claim 8, wherein the active variable-stride write region is defined by registers in the slave device that are configured with a start address pointer and an end address pointer.

10. The method of claim 1, further comprising:
receiving a command code in the datagram; and
enabling a variable-stride write mode in response to the command code.

11. The method of claim 10, wherein the variable-stride write mode is indicated in mode information received in the datagram.

12. The method of claim 11, wherein the mode information defines whether parity bits in the datagram distinguish between register write data and stride values.

13. The method of claim 11, wherein the mode information defines whether the address pointer is to be modified by subtracting the stride value.

14. An apparatus for data communication comprising:
a plurality of registers;
an interface circuit adapted to couple the apparatus to a serial bus; and
a processor configured to:
cause a first data byte received in a first field of a datagram received from the serial bus to be written to a first register, wherein the first register is located at an address indicated by an address pointer;
cause the address pointer to be modified by addition or subtraction of a stride value provided in a second field of the datagram to obtain a modified address pointer; and
cause a second data byte received in a third field of the datagram to be written to a second register in the apparatus, wherein the second register is located at an address indicated by the modified address pointer, and wherein the first register and the second register are located at non-contiguous addresses.

15. The apparatus of claim 14, wherein the second field includes a bit indicating whether the stride value is to be added to the address pointer or subtracted from the address pointer.

16. The apparatus of claim 14, wherein the datagram comprises a stride value that is interleaved between fields carrying a pair of data bytes to be written to non-contiguous registers in the plurality of registers.

17. The apparatus of claim 16, wherein the datagram includes a register address that serves as an initial address pointer, and wherein one or more stride values are provided in the datagram when the initial address pointer indicates an address within an active variable-stride write region.

18. The apparatus of claim 17, wherein the active variable-stride write region is defined by a start address pointer and an end address pointer stored in two or more of the plurality of registers.

19. The apparatus of claim 14, wherein a parity bit of the first field is set to a first value indicating that the first data byte is to be written to the first register, and a parity bit of the second field is set to a second value indicating that the second field carries the stride value.

20. The apparatus of claim 19, wherein the address pointer is modified by adding the stride value to the address pointer.

21. The apparatus of claim 19, wherein the datagram includes a register address that serves as an initial address pointer, and wherein parity bits in the datagram are configured to distinguish between register write data and stride values when the initial address pointer indicates an address within an active variable-stride write region.

22. The apparatus of claim 21, wherein the active variable-stride write region is defined by a start address pointer and an end address pointer stored in two or more of the plurality of registers.

23. The apparatus of claim 14, wherein the processor is further configured to:
receive a command code from the datagram; and
enable a variable-stride write mode in response to the command code.

24. The apparatus of claim 23, wherein the variable-stride write mode is indicated in mode information provided in the datagram.

25. The apparatus of claim 24, wherein the mode information defines whether parity bits in the datagram distinguish between register write data and stride values.

26. The apparatus of claim 24, wherein the mode information defines whether the address pointer can be modified by subtracting the stride value.

27. The apparatus of claim 14, wherein the processor comprises a finite state machine.

28. A processor-readable storage medium comprising code for:
writing a first data byte received in a first field of a datagram from a serial bus to a first register in a slave device, wherein the first register is located at an address indicated by an address pointer;
modifying the address pointer by adding or subtracting a stride value provided in a second field of the datagram to obtain a modified address pointer; and
writing a second data byte received in a third field of the datagram to a second register in the slave device, wherein the second register is located at an address indicated by the modified address pointer, and wherein the first register and the second register are located at non-contiguous addresses.

29. The storage medium of claim 28, wherein the datagram comprises a stride value that is interleaved between fields carrying a pair of data bytes to be written to non-contiguous registers in the slave device.

30. The storage medium of claim 28, wherein a parity bit of the first field is set to a first value indicating that the first data byte is to be written to the first register, and a parity bit of the second field is set to a second value indicating that the second field carries the stride value.
